(19) United States
(12) Patent Application Publication
(10) Pub. No.: US 2026/0340311 A1
(43) Pub. Date: Oct. 29, 2026

(54) ACTIVATION CONTRAST-BASED XAI TECHNOLOGY FOR EXPLAINING PREDICTION REASONS OF TRANSFORMER-BASED AI MODELS

(71) Applicant: Korea University Research and Business Foundation, Seoul (KR)

(72) Inventors: Sang Kyun LEE, Hanam-si (KR); Sung Min HAN, Seoul (KR); Jeong Hyun LEE, Seoul (KR)

(21) Appl. No.: 19/402,721

(22) Filed: Nov. 26, 2025

(30) Foreign Application Priority Data
Nov. 27, 2024 (KR) 10-2024-0172563
Feb. 3, 2025 (KR) 10-2025-0013005

(51) Int. Cl. G06F 40/40; G06F 40/284

(52) U.S. Cl. CPC G06F 40/40; G06F 40/284

(57) ABSTRACT

The present disclosure relates to an apparatus for generating explanation information for generating explanation information for explaining a prediction cause of input data of a transformer model to a target class, including contrast information generation circuitry for generating contrast information by comparing target activation information related to a target class of the transformer model with reference activation information related to a reference class on the basis of token units of the input data, contribution map generation circuitry for generating a contribution map for each token of the input data when the transformer model predicts the class of the input data on the basis of the contrast information, and explanation information generation circuitry for generating token unit explanation information for explaining the prediction cause of the transformer model on the basis of the contribution map for each token.

### CROSS REFERENCE TO RELATED APPLICATIONS

This application claims priority to Korean Patent Application No. 10-2024-0172563, filed on Nov. 27, 2024, and Korean Patent Application No. 10-2025-0013005, filed on Feb. 3, 2025, in the Korean Intellectual Property Office, which are incorporated by reference herein in their entirety.

### TECHNICAL FIELD

The present disclosure relates to an Explainable AI (XAI) technology that can be explained, and more particularly, to an apparatus and method for generating explanatory information that explains the cause of prediction of input data of a transformer model to a target class.

### BACKGROUND

Recently, research on transformer-based deep learning models has been actively conducted and is showing excellent performance in various fields. However, such a transformer model has a complex internal structure such as a multi-attention structure. Since prediction is performed through numerous computational processes, there is a limitation in that it is difficult for humans to intuitively interpret the cause (reason) of the model prediction.

This limitation may be a factor that restricts the use of the transformer model in mission-critical fields such as analysis of sudden acceleration accidents of automobiles as it is difficult for humans to interpret the results of the model prediction. Therefore, it is essential to develop a technology that explains the causes of prediction of the model in a form that humans can understand.

In existing technologies, techniques for evaluating and visualizing the influence of each element of input data on model prediction have been widely used to explain the prediction cause of the model. For instance, one can visualize how much a particular portion of the input data, a pixel region of an image, or a token of text contributed to the prediction outcome, helping to identify key input elements that influenced the prediction.

However, this technique simply indicates which part of the input data the model focuses on, and there is a limitation in highlighting the unique features of the target class by analyzing the differential features between the target class and other classes or removing the common features between the target class and other classes.

In particular, in the field of Natural Language Processing (NLP), there was a lack of technology to precisely analyze the contribution of each token of input data to model prediction and to explain in detail the cause of prediction to the target class based on this contribution.

Therefore, in order to overcome this limitation of the existing technology, it is required to develop a technology that emphasizes the unique features of the target class and analyzes it in detail in token units to explain the cause of prediction of the model.

### SUMMARY

The present disclosure is designed to solve the above technical problems, and an object of the present disclosure is to provide a device and method for generating explanation information describing a cause of prediction of input data of a transformer model to a target class.

According to an aspect of the present disclosure, there is provided an apparatus for generating explanation information for explaining a cause of prediction of input data of a transformer model to a target class, the apparatus comprising: contrast information generation circuitry for generating contrast information by comparing target activation information related to a target class of the transformer model with reference activation information related to a reference class based on a token unit of the input data; contribution map generation circuitry for generating a contribution map for each token of the input data when the transformer model predicts a class of the input data based on the contrast information; and explanation information generation circuitry for generating token unit explanation information for explaining a cause of prediction of the transformer model based on the contribution map for each token.

According to an aspect of the present disclosure, there is provided a method of generating explanation information describing a cause of prediction of input data of a transformer model to a target class, the method including: generating contrast information by comparing target activation information related to a target class of the transformer model with reference activation information related to a reference class based on a token unit of the input data; generating a contribution map for each token of the input data when the transformer model predicts a class of input data based on the contrast information; and generating token unit explanation information describing a cause of prediction of the transformer model based on the contribution map for each token.

According to the above-described embodiment of the present disclosure, by comparing the activation information on the target class with the activation information on the reference class in token units, the feature information of the reference class included in the activation information on the target class may be removed, and thus a token unit contribution map with improved accuracy and precision may be generated.

In addition, the present disclosure provides an effect of minimizing noise that may be generated from the explanation information by emphasizing feature information unique to only the target class and removing the feature information existing in the reference class when generating the contribution map.

### BRIEF DESCRIPTION OF THE DRAWINGS

FIG. 1 is a block diagram illustrating an internal block of an apparatus for generating explanation information of a prediction cause of a transformer model according to an embodiment of the present disclosure.

FIG. 2 is a diagram illustrating a detailed block of a contrast information generation unit of FIG. 1.

FIG. 3 is a diagram illustrating an internal structure of a transformer model according to an embodiment of the present disclosure.

FIG. 4 is a diagram for describing an example in which a contribution map generation unit of FIG. 1 derives an explanation information quality score.

FIG. 5 is a flowchart illustrating an operation of an apparatus for generating explanation information of a prediction cause of a transformer model according to an embodiment of the present disclosure.

Further, skilled artisans will appreciate that elements in the drawings are illustrated for simplicity and may not have necessarily been drawn to scale. For example, the flow charts illustrate the method in terms of the most prominent steps involved to help to improve understanding of aspects of the present invention. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having the benefit of the description herein.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

A detailed description of the present disclosure, which will be described later, refers to the accompanying drawings, which illustrate specific embodiments in which the present disclosure may be practiced as examples. These examples are described in detail to be sufficient for those skilled in the art to practice the present disclosure. It should be understood that the various embodiments of the present disclosure are different from each other but need not be mutually exclusive. For example, certain shapes, structures, and features described herein may be implemented in other embodiments without departing from the spirit and scope of the present disclosure with respect to one embodiment. It should also be understood that the position or arrangement of individual components within each disclosed embodiment may be altered without departing from the spirit and scope of the present disclosure. Accordingly, the detailed description to be described below is not intended to be taken in a limited sense, and the scope of the present disclosure, if properly described, is limited only by the appended claims along with all the scope equivalent to those claimed by the claims. Similar reference numerals in the drawings refer to the same or similar functions across several aspects.

The components according to the present disclosure are components defined by functional classification rather than physical classification, and may be defined by functions performed by each. Each component may be implemented as hardware or a program code and a processing unit that perform each function, and functions of two or more components may be included in one component to be implemented. Accordingly, it should be noted that the names given to the components in the following embodiments are not intended to physically distinguish each component, but are given to imply a representative function in which each component is performed, and the technical spirit of the present disclosure is not limited by the names of the components.

In the entire specification, when a part is described as being “connected” (attached, contacted, coupled) to another part, it includes not only being “directly connected” but also “indirectly connected” through another component. Also, when a part is described as “including” a component, it means that it may further include other components, unless otherwise specified.

The terminology used in this specification is intended only to describe specific embodiments and is not intended to limit the present invention. The singular expressions may include plural expressions unless the context clearly indicates otherwise. In this specification, terms such as “comprise” or “have” are intended to indicate the presence of the stated features, numbers, steps, operations, elements, components, or combinations thereof, and are not intended to exclude the possibility of the presence or addition of one or more other features, numbers, steps, operations, components, or combinations thereof.

In this specification, the term “module” includes a unit configured in hardware, software, or firmware, and may be used interchangeably with terms such as logic, logic block, component, circuit, or circuitry. A module may be an integrated component or the smallest unit performing one or more functions, or a part thereof. For example, the module may be implemented as an application-specific integrated circuit (ASIC).

Hereinafter, exemplary embodiments of the present disclosure will be described in more detail with reference to the drawings.

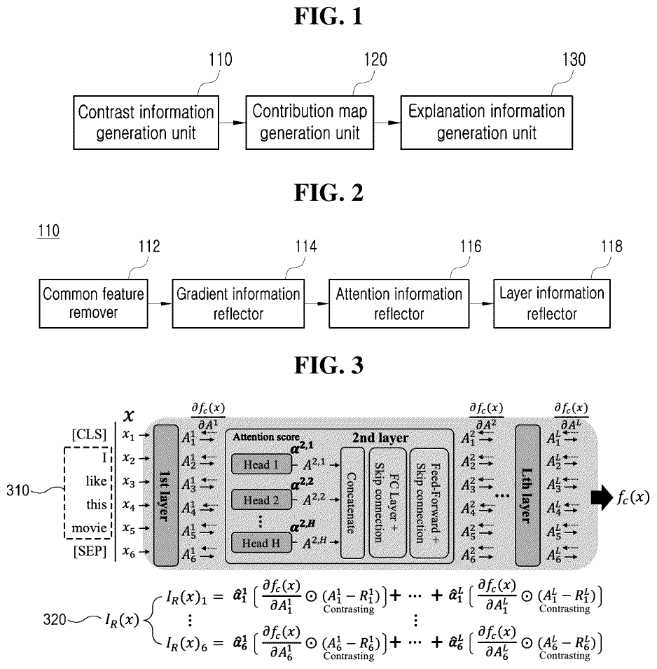

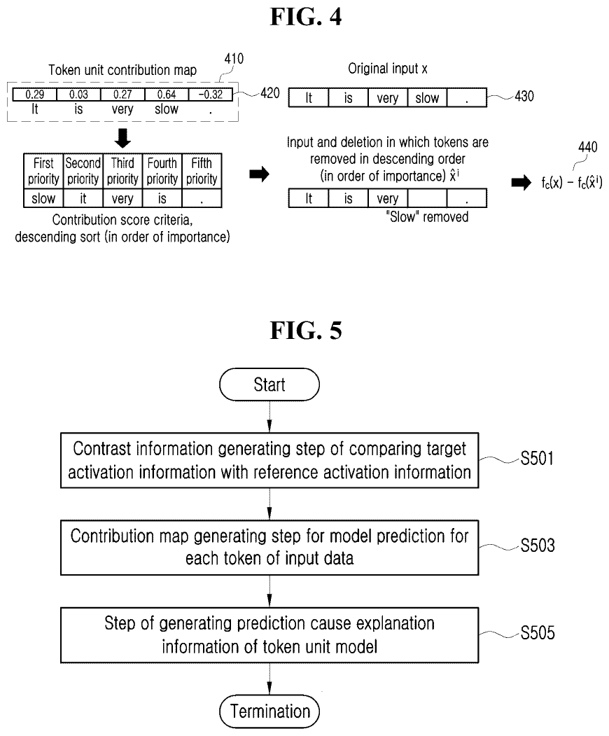

In one embodiment, FIG. 1 is a device diagram illustrating an internal block of an apparatus for generating explanation information for a prediction cause of a transformer model according to an embodiment of the present disclosure. FIG. 2 is a diagram illustrating a detailed block of a contrast information generator of FIG. 1. FIG. 3 is a diagram illustrating an internal structure of a transformer model according to an embodiment of the present disclosure. FIG. 4 is a diagram for describing an example in which a contribution map generation unit of FIG. 1 derives an explanation information quality score.

The illustrated apparatus in FIG. 1 for generating explanation information is an apparatus for generating explanation information for explaining a prediction cause of a transformer model to a target class for input data, and includes a contrast information generation unit 110, a contribution map generation unit 120, and an explanation information generation unit 130. Here, the transformer model refers to a deep learning model based on a transformer architecture. As shown in FIG. 2, the contrast information generation unit 110 includes a common feature remover 112, a gradient information reflector 114, an attention information reflector 116, and a layer information reflector 118.

The contrast information generation unit 110 generates contrast information by comparing target activation information related to the target class of the transformer model and reference activation information related to the reference class based on a token unit of input data. Here, the target activation information is information indicating an activation level of feature information related to the target class, and the reference activation information is information indicating an activation level of feature information related to a class other than the target class, that is, a reference class.

The contribution map generation unit 120 generates a contribution map for each token of the input data when the transformer model predicts the class of the input data based on the contrast information generated through the contrast information generation unit 110. Here, the contribution map visually represents how each token contributed to the prediction of the model, and may be expressed through the contribution score of the model prediction for each token, and the contribution map may be expressed as the equation (Equation 1) below:

$${{I}_{R} ( x )}_{i} := {\sum }_{l = 1}^{L} {\hat{α}}_{i}^{l} {\sum }_{j = 1}^{n} {( \frac{ϑ {f}_{c} ( x )}{ϑ {A}_{i}^{l}} ⊙ ( {A}_{i}^{l} - {R}_{i}^{l} ) )}_{j}$$

In Equation 1, it is assumed that x represents input data, and the input data x is composed of a token sequence as shown in FIG. 3 and may be represented as T×n-dimensional data. In this case, T means the number of tokens in the token sequence, and n means a dimension in which each token is expressed. In addition, the token is a basic unit of input data, and may be a word, a subword, a character, or the like when the input data is text data, and may be an image patch or the like when the input data is image data, but is not limited thereto.

L represents the total number of layers of the transformer model, and l represents the l-th layer. I_{R}(x)ᵢ represents the predicted contribution score of the model for the i-th token of the input data x shown in the contribution map I_{R}(x) generated using the reference activation information R, and

$${\hat{α}}_{i}^{l}$$

represents the average value of the attention score of the l-th layer multi-head attention mechanism for the i-th token as shown in FIG. 3.

The expression

$${A}_{i}^{l}$$

denotes target activation information for a target class of the l-th layer of the transformer model for the i-th token of the input data x, and

$${R}_{i}^{l}$$

denotes reference activation information for a reference class of the l-th layer of the transformer model for the i-th token. As shown in FIG. 3,

$$\frac{ϑ {f}_{c} ( x )}{ϑ {A}_{i}^{l}}$$

represents gradient information of i-th token activation information for a model prediction f_{c}(x) to a target class c, and ⊙ represents an element-wise product operation.

Referring to FIG. 2 in more detail, the contrast generation unit 110 includes a common feature remover 112, a gradient information reflector 114, an attention information reflector 116, and a layer information reflector 118.

In an embodiment, the common feature remover 112 removes the common feature information mixed in the target class and the reference class from the target activation information

$${A}_{i}^{l}$$

by subtracting the target activation information

$${A}_{i}^{l}$$

and the reference activation information

$${R}_{i}^{l}$$

based on the token unit. Through this, the common feature remover 112 may extract activation information of feature information existing only in the target class targeted for explanation. The reference activation information

$${R}_{i}^{l}$$

is selected as activation information of data having a high probability of the transformer model for the original class (a class different from the target class) but a low prediction probability value (10−4 or less) for the target class. This is to maximally eliminate feature information about other classes from the target activation information at the time of difference.

The common feature remover 112 performs a comparison process between the target activation information

$${A}_{i}^{l}$$

and the reference activation information

$${R}_{i}^{l}$$

on an tokens Irom i=1, . . . , T.

In an embodiment, the gradient information reflector 114 performs a product operation on the target activation information

$${A}_{i}^{l} - {R}_{i}^{l} .$$

That is, the gradient information reflector 114 performs the operation from which the common feature information is removed through the common feature remover 112 and the gradient information

$$\frac{ϑ {f}_{c} ( x )}{{ϑ}_{i}^{l}}$$

of the target activation information

$${A}_{i}^{l}$$

for the prediction f_{c}(x) to the target class for each feature information, and reflects the contribution to the prediction for each feature information.

Through this, the gradient information reflector 114 may reflect the degree to which each feature information in the activation information actually contributes to the prediction of the transformer model as the target class c.

In an embodiment, the attention information reflector 116 applies the average value of the attention score

$${\hat{α}}_{i}^{l}$$

including the relationship between all tokens of the input data to the target activation information

$${\sum }_{j = 1}^{n} {( \frac{ϑ {f}_{c} ( x )}{ϑ {A}_{i}^{l}} ⊙ ( {A}_{i}^{l} - {R}_{i}^{l} ) )}_{j}$$

in which the gradient information is product-calculated through the gradient information reflector 114 to reflect the relationship information between the tokens.

The layer information reflector 118 derives target activation information

$${\hat{α}}_{i}^{l} {\sum }_{j = 1}^{n} {( \frac{ϑ {f}_{c} ( x )}{ϑ {A}_{i}^{l}} ⊙ ( {A}_{i}^{l} - {R}_{i}^{l} ) )}_{j}$$

to which the average value of the attention score is applied through the attention information reflector 116 for all layers from l=1, . . . , L of the transformer model, and then sums them.

Meanwhile, the apparatus for generating explanation information proposed in the present disclosure basically generates a contribution map using single reference activation information but may also generate a contribution map using multiple reference activation information in order to more precisely remove unnecessary information mixed with the target activation information. In this case, the contrast information generation unit 110 generates the multi-contrast information by comparing the multi-reference activation information and the target activation information based on a token unit. In this case, the multi-reference activation information may be prepared in advance in the form of a reference activation library or may be newly extracted in the process of generating explanation information. When the multi-reference activation information is prepared in advance in the form of a reference activation library, the multi-reference activation information is selected as activation information of data having a high probability of a transformer model for an original class (a class different from a target class) but a low prediction probability value (10−4 or less) for a target class.

In an embodiment, the contribution map generation unit 120 generates contribution maps I_{R(r)}(x)(R(r), r=1, . . . , N) corresponding to the number of multiple activation information based on the multiple contrast information generated by the contrast information generation unit 110. That is, the contribution map generation unit 120 generates a contribution map candidate group based on the multi-contrast information, and derives an explanation information quality score for each of the contribution maps included in the contribution map candidate group according to the equation (Equation 2) below:

$$\frac{1}{T} {\sum }_{i = 1}^{T} [ {f}_{c} ( x ) - {f}_{c} ( {\hat{x}}^{i} ) ]$$

Here, f_{c}(x) represents a predicted probability value of the target class c for the input data x of the transformer model, and f_{c} (\hat{x}ⁱ) represents a predicted probability value of the transformer model when the token having the highest contribution score, that is “slow”, is removed according to the descending order of the token unit contribution scores as shown in FIG. 4.

Thereafter, the contribution map generation unit 120 derives a final contribution map by excluding a contribution map whose quality score derived through Equation 2 is less than a specific threshold from the contribution map candidate group, and then calculating an average for the remaining contribution maps.

Referring back to FIG. 1, the explanation information generation unit 130 generates token unit explanation information explaining the prediction cause of the transformer model based on the contribution map for each token generated through the contribution map generation unit 120. FIG. 5 is a flowchart illustrating an operation of an apparatus for generating prediction cause explanation information of a transformer model according to an embodiment of the present disclosure. Although shown in a sequence, other possible order of operations and sequencing of events are possible.

At step S501, the apparatus for generating explanation information generates contrast information by comparing target activation information related to the target class of the transformer model with reference activation information related to the reference class based on a token unit of input data.

Then at step S503, the apparatus for generating explanation information generates a contribution map for each token of the input data when the transformer model predicts the class of the input data based on the contrast information generated in the S501.

Thereafter at step S505, the explanation information generating device generates token unit explanation information explaining the prediction cause of the transformer model based on the contribution map for each token generated in the S503.

The method of generating explanation information for explaining the prediction cause of the transformer model to the target class for input data according to the present disclosure may be implemented in the form of program instructions that may be executed through various computer components and recorded in a computer-readable recording medium. The computer-readable recording medium may include program instructions, data files, data structures, and the like alone or in combination.

The program instructions recorded in the computer-readable recording medium may be specially designed and configured for the present disclosure or may be known to and used by those skilled in the field of computer software.

Examples of the computer-readable recording medium include a magnetic medium such as a hard disk, a floppy disk, and a magnetic tape, an optical recording medium such as a CD-ROM and a DVD, a magneto-optical medium such as a floptical disk, and a hardware device specially configured to store and execute program instructions such as a ROM, a RAM, a flash memory, and the like.

Examples of program instructions include not only machine language codes such as those generated by a compiler, but also high-level language codes that may be executed by a computer using an interpreter or the like. The hardware device may be configured to operate as one or more software modules to perform processing according to the present disclosure, and vice versa.

Although various embodiments of the present disclosure have been illustrated and described above, the present disclosure is not limited to the specific embodiments described above, and various modifications can be made by a person skilled in the art to which the present disclosure belongs without departing from the gist of the present disclosure claimed in the claims, and such modifications should not be individually understood from the technical spirit or the prospect of the present disclosure.

A phrase “at least one of” preceding a series of times, with the terms “and” or “or” to separate any of the times, modifies the list as a whole, rather than each member of the list. The phrase “at least one of” does not require a selection of least one item, rather, the phrase allows a meaning that includes at least one of any one of the items, and/or at least one of any combination of the items, and/or at least one of each of the items. By way of example, each of the phrases “at least one of A, B, and C” or “at least of A, B, or C” refers to Only A, only B, only C, any combination of A, B, and C, and/or at least each of A, B, and C.

1. An apparatus for generating explanation information for explaining a prediction cause of input data of a transformer model to a target class, the apparatus comprising:
contrast information generation circuitry for generating contrast information by comparing target activation information related to the target class of the transformer model with reference activation information related to a reference class based on a token unit of the input data;
contribution map generation circuitry for generating a contribution map for each token of the input data when the transformer model predicts a class of input data based on the contrast information; and
explanation information generation circuitry for generating token unit explanation information for explaining a prediction cause of the transformer model based on the contribution map for each token.

2. The apparatus of claim 1, wherein the contrast information generation circuitry comprises:
a common feature remover configured to subtract the target activation information and the reference activation information based on the token unit and remove common feature information of the target class and the reference class from the target activation information;
a gradient information reflector configured to perform a product operation on the target activation information from which the common feature information is removed and gradient information of the target activation information for the prediction of the target class for each feature information to reflect a contribution to the prediction;
an attention information reflector configured to reflect relationship information between tokens by applying an average value of attention scores representing a relationship between all tokens of the input data to the target activation information from which the gradient information is performed; and
a layer information reflector configured to derive and then add target activation information to which the average value of the attention scores is applied to all layers of the transformer model.

3. The apparatus of claim 1, wherein the contrast information generation circuitry generates the multi-contrast information by comparing the multi-reference activation information of the reference activation library prepared in advance with the target activation information based on the token unit.

4. The apparatus of claim 3, wherein the contribution map generation circuitry is configured to:
generate a contribution map candidate group based on the multi-contrast information;
derive an explanation information quality score for each of the contribution maps included in the contribution map candidate group according to a predetermined formula;
exclude a contribution map whose quality score is less than a specific threshold from the contribution map candidate group; and
calculates an average of the remaining contribution maps to derive a final contribution map.

5. The apparatus of claim 4, wherein the explanation information quality score is derived based on a prediction probability value of the transformer model when a token having the highest contribution score is removed according to a descending order of a prediction probability value to the target class for the input data of the transformer model and a token unit contribution score.

6. A method of generating explanation information for explaining a cause of prediction of input data of a transformer model to a target class, the method comprising:
generating contrast information by comparing target activation information related to the target class of the transformer model with reference activation information related to a reference class based on token units of the input data;
generating a contribution map for each token of the input data when the transformer model predicts a class of input data based on the contrast information; and
generating token unit explanation information for explaining a cause of prediction of the transformer model based on the contribution map for each token.

7. The method of claim 6, wherein the generating of the contrast information comprises:
subtracting the target activation information and the reference activation information from the target activation information based on the token unit to remove common feature information of the target class and the reference class from the target activation information;
performing a product operation on the target activation information from which the common feature information is removed and gradient information of the target activation information for prediction to the target class for each feature information to reflect a contribution to the prediction;
applying an average value of an attention score indicating a relationship between all tokens of the input data to the target activation information from which the gradient information is performed to reflect relationship information between tokens; and
deriving and then summing the target activation information to which the average value of the attention score is applied for all layers of the transformer model.

8. The method of claim 6, wherein the generating of the contrast information comprises:
generating the multi-contrast information by comparing the multi-reference activation information of the reference activation library prepared in advance with the target activation information based on the token unit.

9. The method of claim 8, wherein the generating of the contribution map comprises:
generating a contribution map candidate group based on the multi-contrast information;
deriving an explanation information quality score for each of the contribution maps included in the contribution map candidate group according to a predetermined formula;
excluding a contribution map whose quality score is less than a specific threshold from the contribution map candidate group; and
calculating an average of the remaining contribution maps to derive a final contribution map.

10. The method of claim 9, wherein the explanation information quality score is derived based on a prediction probability value of the transformer model when a token having the highest contribution score is removed according to a descending order of a prediction probability value to the target class for the input data of the transformer model and a token unit contribution score.

11. The apparatus of claim 2, wherein the reference activation information is selected as activation information of data having a high probably of the transformer model for an original class but a low prediction probability value for the target class.

12. The apparatus of claim 1, wherein the target activation information is information indicating an activation level of feature information related to the target class and the reference activation information is information indicating an activation level of feature information related to a class other than the target class.

13. The method of claim 7, wherein the reference activation information is selected as activation information of data having a high probably of the transformer model for an original class but a low prediction probability value for the target class.

14. The method of claim 6, wherein the reference activation information is selected as activation information of data having a high probably of the transformer model for an original class but a low prediction probability value for the target class.
